(19) United States
(12) Patent Application Publication
(10) Pub. No.: US 2004/0244348 A1
(43) Pub. Date: Dec. 9, 2004

(54) Ground-following lawn mower cutter deck suspension system

(76) Inventor: Joseph S. Ferris, Charlotte, NC (US)

Correspondence Address: BROWN & MICHAELS, PC, 400 M & T BANK BUILDING, 118 NORTH TIOGA ST, ITHACA, NY, 14850, US

(21) Appl. No.: 10/811,770

(22) Filed: Mar. 29, 2004

Related U.S. Application Data
(63) Continuation-in-part of application No. 09/820,060, filed on Mar. 28, 2001, now Pat. No. 6,711,885.

(51) Int. Cl. A01D 34/03

(52) U.S. Cl. 56/15.8

(57) ABSTRACT

An improved lawn mower includes a chassis assembly having one or more drive wheels, a ground-following cutter deck assembly attached to the chassis, and rolling means attached to the cutter deck, wherein the chassis and the cutter deck are arranged such that the rolling means and the drive wheels support the chassis for movement over a surface. The ground-following cutter deck thereby reacts to the ground contours independent of the reactions of the chassis, and the combined weight of the chassis and cutter deck keep the cutter deck from bouncing, thus, the ground-following cutter deck follows the ground contours evenly.

### REFERENCE TO RELATED APPLICATIONS

This is a continuation-in-part patent application of copending application Ser. No. 09/820,060, filed Mar. 28, 2001, entitled “GROUND-FOLLOWING LAWN MOWER CUTTER DECK SUSPENSION SYSTEM”. The complete disclosure of the aforementioned application is hereby incorporated herein by reference in its entirety.

### BACKGROUND OF THE INVENTION

1. Field of the Invention

The invention pertains to the field of lawn mowers. More particularly, the invention pertains to a lawn mower wherein the lawn mower chassis rests on top of a ground-following lawn mower cutter deck.

2. Description of Related Art

A typical lawn mower chassis and a typical ground-following cutter deck of the prior art each include supports holding the chassis and cutter deck in relation to the ground. Typically, these supports are wheels, but they optionally comprise rollers, skids, or other suitable support means. One problem in the prior art is that such a combination of conventional elements generally does not maintain an even grass cut, due to the up and down vertical motion inherent in such systems. In particular, chassis roll and pitch and cutter deck bouncing can affect adversely the evenness of the grass cut.

FIG. 1 shows a typical ground-following lawn mower cutter deck of the prior art. This design has a cutter deck frame 3 from which cutter deck 10 hangs. Cutter deck 10 includes deck wheels 9 and a deck lift assembly that includes deck lift mechanism 16, chains or cables (not shown), and deck lift linkages 5. Deck lift mechanism 16 is what the operator physically actuates to lift the cutter deck, for example, when not mowing. Typically, the cutting height adjustment is made after the deck lift mechanism has been actuated and the cutter deck is in its upward position. Each of the foregoing parts are common in prior art designs for adjusting and maintaining the lawn mower's cutting height. However, typical lawn mowers of the prior art can also include other conventional designs. For example, the wheels can be mounted directly from the cutter deck and cantilevered from that position (not shown), or the cutter deck 10 can be connected to the chassis frame 2 through the use of cutter deck pusher bars 15, or other similar conventional means. A conventional chassis frame 2 is typically one of the main components of the lawn mower. In many cases, chassis frame 2 is the structure to which most of the other parts of the lawn mower are attached. The prior art lawn mower typically has three to four wheels that support its weight and allow for its movement over a surface, such as the lawn being cut. Typically, all parts having to do with the lawn mower's speed and direction are attached to the chassis frame.

The combination of a ground-following cutter deck and a conventional lawn mower chassis, be it a tractor or a zero turning radius lawn mower (as described above), allows both components to interact with the surface contours of the ground, independently of each others' reactions to ground surface contours. However, in the prior art designs, the cutter deck can bounce and thereby fail to follow the ground contours. In attempts to solve this problem, some prior art lawnmowers have been designed such that the cutter deck hangs directly from the chassis frame, whereby the cutter deck responds directly to chassis movement, rather than to the ground contours. Such designs are typically referred to in the art as a “floating deck” design, because the cutter deck “floats” over the ground surface, as opposed to a ground-following deck, which typically rolls over the ground.

However, the floating deck design does not completely resolve the common problems with ground-following cutter decks, and the floating deck has its own inherent problems. More particularly, floating deck designs can result in an uneven grass cut, when uneven or bumpy ground contours cause the chassis, from which the floating deck hangs, to move up and down vertically, and pitch and roll, thereby causing the floating deck also to move up and down, and pitch and roll, thus resulting in an uneven grass cut.

### SUMMARY OF THE INVENTION

Briefly stated, an improved lawn mower design includes a chassis assembly having one or more drive wheels, a ground-following cutter deck assembly attached to the chassis, and rolling means attached to the cutter deck, wherein the chassis and the cutter deck are arranged such that the rolling or sliding means and the drive wheels support the chassis for movement over a surface. The ground-following cutter deck thereby reacts to the ground contours independent of the reactions of the chassis, and the combined weight of chassis and cutter deck keep the deck from bouncing, thus, the ground-following cutter deck follows the ground contours evenly.

### BRIEF DESCRIPTION OF THE DRAWING

FIG. 1 shows a typical ground-following lawn mower cutter deck of the prior art.

FIG. 2 shows a zero turning-radius lawn mower, according to an embodiment of the present invention.

FIG. 3 shows a lawn/garden tractor with a ground-following lawn mower cutter deck attached to its chassis, according to the present invention.

FIGS. 4-9 show various embodiments of the invention.

### DETAILED DESCRIPTION OF THE INVENTION

One problem with prior art lawn mowers is that the typical combinations of conventional elements generally do not maintain evenness of the grass cut. In particular, chassis roll and pitch and cutter deck bouncing can affect adversely the evenness of the grass cut by prior art lawn mowers. The present invention addresses the problems of chassis roll and pitch and cutter deck bouncing, which undesirably change the elevation of the cutter deck with respect to the lawn being cut, thereby resulting in an uneven grass cut. The present invention further offers the benefits of being easily produced and enabling an increased mowing speed over prior art lawn mowers.

The invention is a unique combination and refinement of conventional technologies used in lawn mowers. It comprises, in its most basic form, a ground-following cutter deck with a lawn mower chassis resting upon it, via a suspension system. Thus, by putting the weight of the chassis on top of the ground-following cutter deck, the common problems in prior art lawn mowers of chassis roll and pitch and cutter deck bouncing are alleviated. To add weight to the cutter deck, in one embodiment of the invention, the third and fourth chassis wheels, which are typically the front steering wheels, are removed. The entire cutter deck assembly thereby functions substantially as an axle of the lawn mower (e.g., the lawn/garden tractor), and its up and down movement is independent of chassis up and down action. The front wheels of the ground-following cutter deck thus also function as wheels for steering the lawn mower, or, alternatively, simply as support means for the chassis. In addition, when the front chassis wheels are thus eliminated from the prior art lawn mower chassis, the overall length of the lawn mower is thereby decreased, which facilitates turning the lawn mower and mowing in tight spaces. A further advantage of the present invention is that the cutter deck and the chassis respond independently of each others' reactions to ground contours. Thus, the cutter deck is able to follow the contours of the terrain, without reacting to chassis up and down motion, and without bouncing, thereby providing a more even grass cut. Preferably, a suspension system is located between the cutter deck and the chassis.

Improved Linkage for Connecting Ground-Following Cutter Deck to Chassis

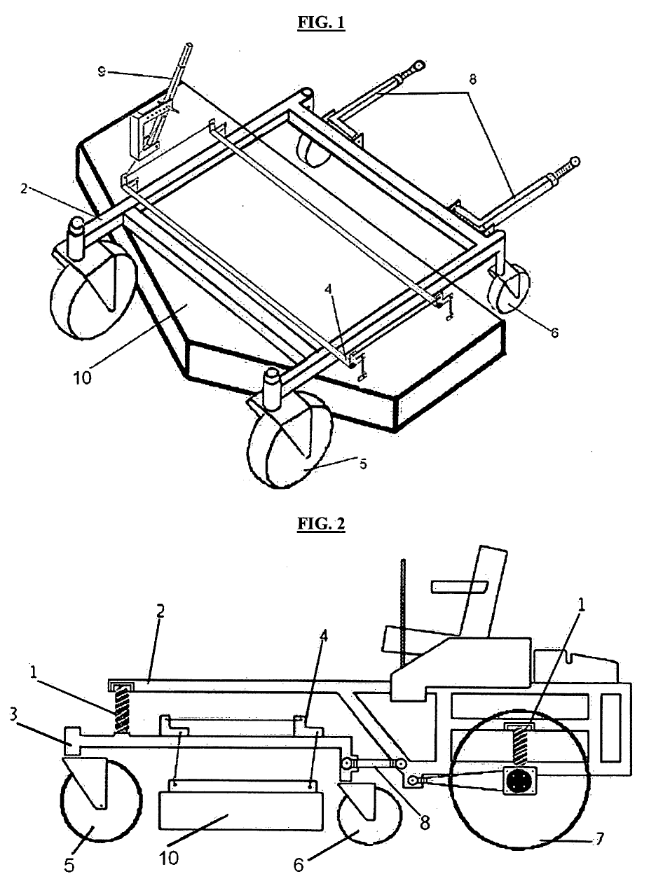

The invention further provides an improved means to connect a ground-following cutter deck (FIG. 1.) to the chassis of a machine. It allows the ground-following cutter deck to cut the grass more efficiently and evenly. Normally a ground-following cutter deck could cut the same blade of grass more than once leaving a poor quality of cut and requiring more energy/engine horsepower from the machine. With the improved linkages a grass blade will be cut once, requiring less energy/horsepower and increasing it's efficiency. Additionally, under rough conditions the trailing edge of the ground-following cutter deck can scalp the ground surface. With the improved linkages scalping is less likely to occur.

Conventional means are used to manage the motion of the ground-following cutter deck so that it maintains its' ground-following quality of cut. Improved connections between the chassis and the ground-following cutter deck will control the vertical movement of the rear of the cutter deck. The trailing edge or rear edge of the cutter deck will never be lower then the leading edge, or the front edge of the cutter deck. Additionally, the trailing edge will be able to move vertically higher then, or greater than the height of the leading edge.

Conventional means used in automobile suspension would be arranged to connect the Ground-following cutter deck in a unique way. The arrangement of the linkages is very similar to the arrangement of linkages used to connect an axle on an automobile or pickup truck. There are many ways to arrange the linkages as well as other conventional means that will provide the same outcome.

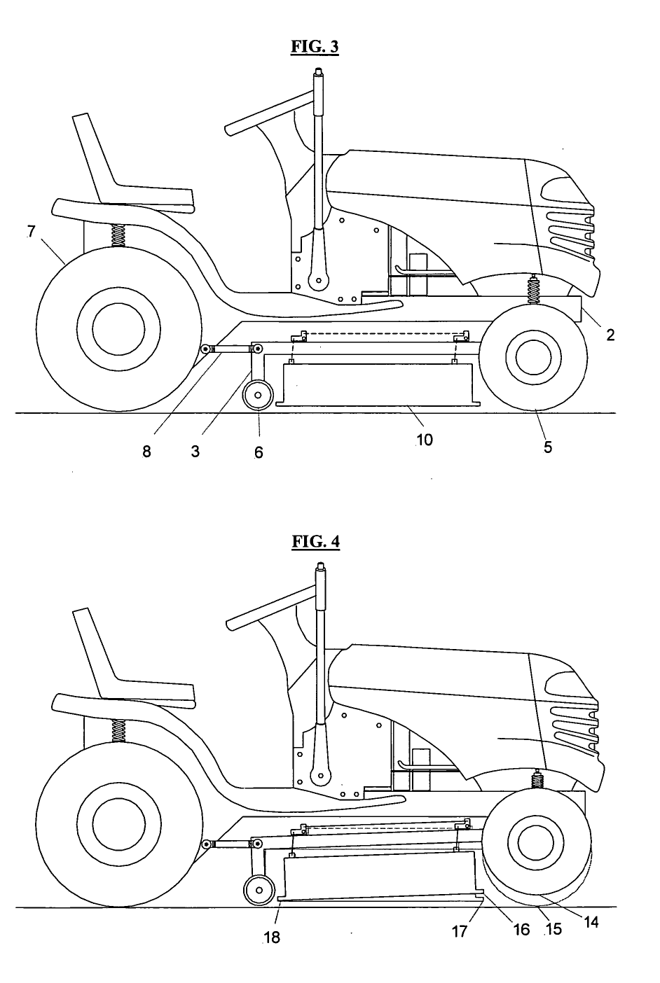

A ground-following cutter deck (FIG. 1) has means of supporting itself. For this discussion we will use wheels, front (FIG. 1, #5) and rear (FIG. 1, #6). Additionally, the cutter deck will be used as an axle, or support for the front machines Chassis (FIG. 2, #2). The front of the chassis will rest on a suspension (FIG. 2, #1) and linkages (FIG. 2, #8) will be used to connect the chassis to the cutter deck. The improved linkages can be used on any mower using such a configuration. FIG. 2 illustrates and Zero turning radius lawnmower and FIG. 3 illustrates a garden, or Lawn tractor using the same configuration or relationship between the ground-following cutter deck and chassis.

Normally the chassis (FIG. 3, #2) manages the horizontal motion of the cutter deck. The horizontal motion would be better described as direction traveled across a lawn, left right or straight and at what speed. The vertical movement is dictated by the contours of the ground surface. The suspensions springs placed between the Chassis (FIG. 2, #1) and connection linkages (FIG. 2, #8) allow the cutter deck to directly follow the contours of the surface independent of the chassis movement.

When the front tire is raised from a bump or ground contour change, the tire will move vertically (from FIG. 4, #15 to #14) while the chassis position remains unchanged. The trailing edge or rear of the cutter deck (FIG. 4, #18) will be lower the front edge (FIG. 4 #16.) The leading will cut the grass at greater vertical position then the height of the trailing edge of the cutter deck. When the trailing edge of the cutter deck passes the same blade of grass the difference in height between the two edges of the cutter deck will be cut off the grass blade. The grass Blade is cut more then once when this occurs.

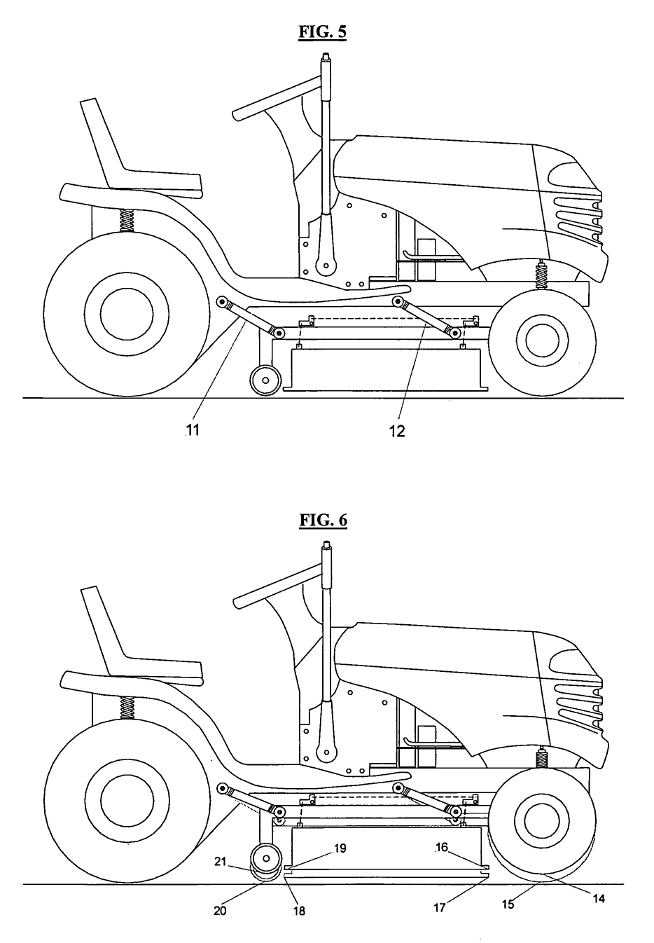

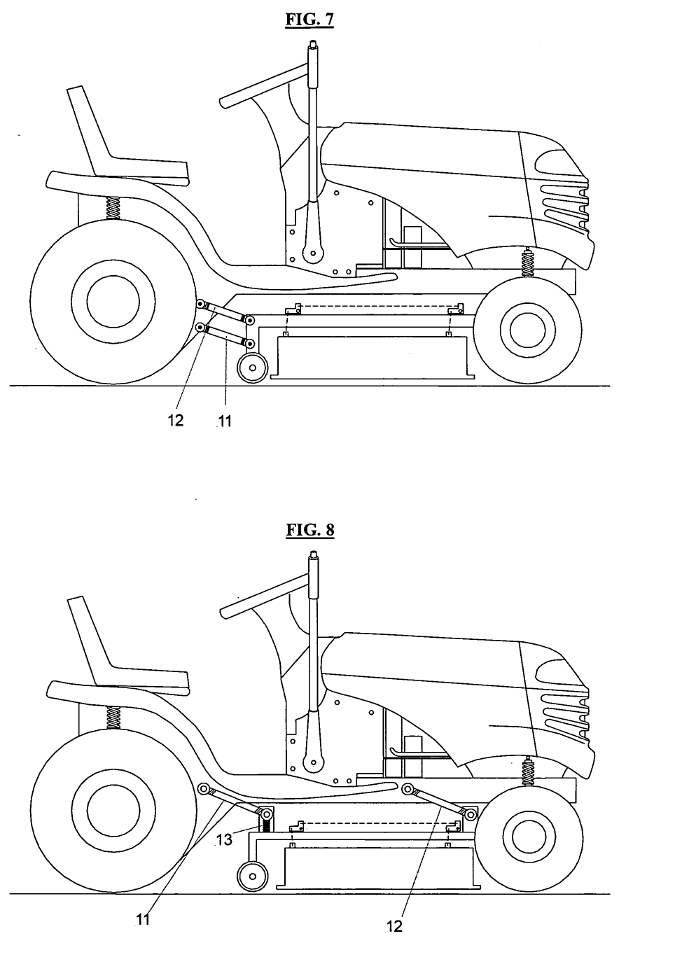

Double cutting the grass blade can be alleviated by using linkages arranged similar to that on an automobile with a solid axles. Linkages arranged in parallel (FIG. 5, #11, #12) will require the leading edge and trailing edge to maintain the same vertical location. When the front wheel hits a bump both edges of the cutter deck (FIG. 6, #18, #17) will be raised the same amount (FIG. 6, #19, #16.) The same will occur when the rear wheel of the cutter deck hits a bump (FIG. 6. #20 to 2.). The linkages can be located along the top of the cutter deck (FIG. 5, #11, and #12) or connected to the front or rear (FIG. 7, #11, #12.) in same manor.

The parallel linkages will require to leading and trailing edges of the cutter deck to maintain the same distance from the ground surface. The leading edge will mimic the vertical movement of the trailing edge and the trailing edge will mimic the movement of leading edge. When the rear wheel of the cutter deck (FIG. 6, # 20) hits a pump and is lifted (FIG. 6, # 21) the leading edge (FIG. 6, #17-16) will be lifted the same amount. The front wheel will be lifted from the ground the same amount (FIG. 6, # 15-14.) When the wheel is lifted traction is lost. Steering of some machines will be lost when the front wheel is lifted from the ground. This can be corrected.

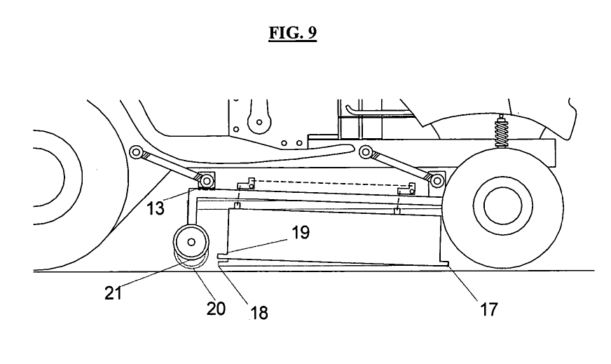

Using additional linkages or springs (FIG. 8. #13) will prevent the front wheel from being lifted from the ground when the rear wheel of the cutter deck hits a bump. A spring used in conjunction with a linkage arm (FIG. 8, #11 and #13) will allow the rear wheel to move vertically without affecting the height of the front wheel. The spring will compress (FIG. 9, # 13) the same amount as the height of the pump and allow the front wheel to stay in contact with the ground. Linkages can come in many shapes and forms. Simple rods will spherical rod ends or rubber bushings are typically used. A limiting strap could be used on the rear of the ground-following cutter deck to achieve the same relationship. Preferred lengths and several different mounting locations of the linkages would allow for the movement previously described.

The linkages length and shape can be changed to allow the weight from the chassis to be focused on the front wheels of the ground-following cutter deck. This would allow the steering wheels of some machines to have better traction and maintain the same quality of cut.

One of ordinary skill in the art can see how the invention can be applied to other styles of lawn mowers. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A lawn mower, comprising:
a) a chassis assembly having one or more drive wheels;
b) a ground-following cutter deck assembly attached to said chassis; and
c) rolling or sliding means attached to said cutter deck, wherein said chassis and said cutter deck are arranged such that said rolling or sliding means and said drive wheels support said chassis for movement over a surface.

2. A lawn mower, comprising:
a) a chassis assembly having one or more drive wheels;
b) a ground-following cutter deck assembly attached to said chassis;
c) rolling or sliding means attached to said cutter deck, wherein said rolling or sliding means is selected from the group consisting of:
i) wheels;
ii) rollers;
iii) skids; and
iv) any combination of i-iv above; and
wherein said chassis and said cutter deck are arranged such that said rolling or sliding means and said drive wheels support said chassis for movement over a surface.

3. The lawn mower of claim 1, wherein each drive wheel is independently powered.

4. The lawn mower of claim 1, wherein each drive wheel is not independently powered.

5. The lawn mower of claim 1, further comprising a suspension system.

6. The lawn mower of claim 5, wherein said suspension system comprises one or more spring means between said chassis and said drive wheels.

7. The lawnmower of claim 6, wherein said spring means is selected from the group consisting of:
a) a coil spring;
b) a leaf spring; and
c) a torsion bar.

8. The lawn mower of claim 5, wherein said suspension system comprises one or more spring means between said chassis and said cutter deck assembly.

9. The lawnmower of claim 8, wherein said spring means is selected from the group consisting of:
a) a coil spring;
b) a leaf spring; and
c) a torsion bar.

10. The lawn mower of claim 1, wherein each drive wheel is capable of moving vertically up and down, substantially independently of vertical movement of an opposing drive wheel.

11. The lawn mower of claim 1, wherein each drive wheel is capable of moving vertically up and down, but not independently of vertical movement of an opposing drive wheel.

12. The lawn mower of claim 1, wherein said cutter deck substantially functions as an axle means.

13. The lawn mower of claim 12, wherein said cutter deck is capable of moving vertically up and down, substantially independently of vertical movement of said chassis.

14. The lawn mower of claim 1, wherein said rolling means substantially functions as a steering means.

15. The lawn mower of claim 1, wherein said cutter deck and said chassis are capable of responding substantially independently of each others' reactions to ground contours.

16. The lawn mower of claim 6, further comprising means for adjustably precompressing said spring means.

17. The lawn mower of claim 8, further comprising means for adjustably precompressing said spring means.

18. The lawn mower of claim 1, further comprising means for adjusting a cutting height of said cutter deck.

19. The lawn mower of claim 1, further comprising means for lifting said cutter deck.

20. A lawn mower, comprising:
a) a chassis assembly;
b) one or more drive wheels operably connected to said lawn mower;
c) a ground-following cutter deck assembly attached to said chassis; and
d) one or more wheels, rollers or skids attached to said cutter deck, wherein said chassis and said cutter deck are arranged such that said one or more wheels, rollers or skids and said drive wheels support said chassis for movement over a surface.

21. The lawn mower of claim 20, wherein said one or more drive wheels are attached to said cutter deck assembly.
